(19) United States
(12) Patent Application Publication
(10) Pub. No.: US 2021/0331731 A1
(43) Pub. Date: Oct. 28, 2021

(54) SHOPING CART HYGIENIC GRIPS

(71) Applicant: TRINTEC INDUSTRIES INC., Ajax (CA)

(72) Inventors: Brendon NUNES, Ajax (CA); Michael PERROTTA, Ajax (CA)

(73) Assignee: TRINTEC INDUSTRIES INC.

(21) Appl. No.: 17/300,192

(22) Filed: Apr. 8, 2021

Related U.S. Application Data
(60) Provisional application No. 63/101,269, filed on Apr. 22, 2020.

(51) Int. Cl. B62B 5/06

(52) U.S. Cl. CPC B62B 5/069

(57) ABSTRACT

A hygienic grip for a cart handle, such as a shopping cart, utilizes a flexible element dimensioned and configured so that when it is deformed by moving it into contact with a cart handle it will move into place to grip the cart handle. The grip also includes a remote mounting structure, desirably a plastic pistol grip handle which is securely mounted to the flexible element for holding the flexible element in place during use and facilitating movement of the flexible element on and off a cart handle without the possibility of the user inadvertently touching the cart handle. The flexible element desirably is a rubber-like element having a generally U-shaped portion.

### CROSS-REFERENCE TO RELATED APPLICATION

This application claims the priority of U.S. Provisional Application Ser. No 63/101,269 filed Apr. 22, 2020, the disclosure of which is incorporated by reference herein.

### BACKGROUND AND SUMMARY OF THE INVENTION

For many years health conscious shoppers using shopping carts, such as grocery carts, have been concerned with the hygiene of the cart handles. Shoppers have been and are disturbed by the possibility of picking up flu, Covid-19, or cold viruses, as well as bacterial infections, if a prior user has a disease or illness and transfers infectious materials onto the cart handle. Because of this there have been dozens of proposals for allowing a user to avoid touching a cart handle when using the cart, such as shown in U.S. Pat. Nos. 5,215,319, 5,820,142, 6,817,065, D521,207, and 8,276,626. Many of these proposals utilize one-time-use devices, which can be wasteful, and most of them—while effective once installed—can't avoid the possibility of the user inadvertently touching the cart handle during the installation or removal process.

A device and method according to the present invention provide for installation of a sanitary device which remotely separates the user from the cart handle during the installation and removal procedures so that the possibility of inadvertently touching the handle during installation or removal of the hygienic device is essentially zero. The device according to the invention may be reused indefinitely and easily sanitized between uses by employing an alcohol or like spray or wipe on the only portion of the device which ever contacts the cart handle. Also, the device of the invention additionally allows the user more comfortable and effective control of the grocery/shopping cart during use.

According to one aspect of the present invention there is provided a hygienic grip. The grip comprises: a plastic (e. g. ABS, although almost any relatively rigid plastic, including glass filled polypropylene and polystyrene, is suitable) pistol grip handle (such as shown per se in U.S. Pat. Nos. 5,960,549, 6,003,787, and 7,731,716); and a flexible element having a roughly U-shaped configuration portion mounted securely by the plastic pistol grip handle with the open portion of the U facing outwardly from the pistol grip handle. The flexible element is dimensioned and configured so that when it is deformed by moving it into contact with a cart handle (of a shopping cart or the like) it will move into place to grip the cart handle. For example the flexible element can be of a rubber-like material such as EPDM, silicone rubber, natural rubber, neoprene rubber, or the like. The legs of the generally U-shaped portion can elastically and/or frictionally engage the shopping cart handle to hold the hygienic grip in place and/or the legs may “snap” around the shopping cart handle to hold the hygienic grip in place with the shopping cart handle also engaging the curved closed portion of the U.

According to another aspect of the invention there is provided a hygienic grip for a cart handle. The hygienic grip comprises: a flexible element dimensioned and configured so that when it is deformed by moving it into contact with a cart handle it will move into place to grip a cart handle; and a remote mounting structure for holding the flexible element in place during use and facilitating movement of the flexible element on and off a cart handle without the possibility of the user inadvertently touching the cart handle. The flexible element may comprise a rubber-like element having a generally U-shaped portion. The remote mounting structure may comprise a plastic pistol grip handle which is securely mounted to the flexible element and can effectively control the cart when in use. The pistol grip handle may comprise an ergonomic curved sculptured portion adapted to be engaged by a user's fingers.

According to another aspect of the present invention there is provided a method of using a cart having an elongated handle using first and second hygienic grips as discussed above by: a) moving the flexible elements of the grips into contact with spaced portions of the elongated cart handle using only the remote mounting structure so that there is no probability of the user inadvertently touching the cart handle; and b) ultimately removing the hygienic grip from contact with the cart handle using only the remote mounting structure. The method may further comprise: c), after b), sanitizing the portions of each of the flexible elements that contacted the cart handle. Also, c) may be practiced using an at least 60% alcohol spray, or an alcohol wipe, and the hygienic grips may be stored in a plastic bag for future use.

According to yet another aspect of the present invention there is provided a hygienic grip comprising a plastic pistol grip handle and a generally U-shaped portion adapted to engage a generally circular cross-section cart handle.

It is the primary object of the present invention to provide hygienic grips, and a method of utilization thereof, that allow completely sanitary use of a shopping cart handle or the like, and even more comfortable and effective control of the cart during shopping. This and other objects of the invention will become clear from a detailed description of the drawings, and from the appended claims.

### BRIEF DESCRIPTION OF THE DRAWINGS

FIG. 1 is a perspective view of an exemplary hygienic grip according to the invention for a shopping cart or the like;

FIG. 2 is a side view of the hygienic grip of FIG. 1 in use contact with a shopping cart handle; and

FIG. 3 is an exploded perspective view of the hygienic grip of FIG. 1.

### DETAILED DESCRIPTION OF THE DRAWINGS

An exemplary hygienic grip according to the invention is shown generally by reference numeral 10 in the drawings. The grip 10 preferably has two main components, the plastic pistol grip handle 12 and the flexible element 14.

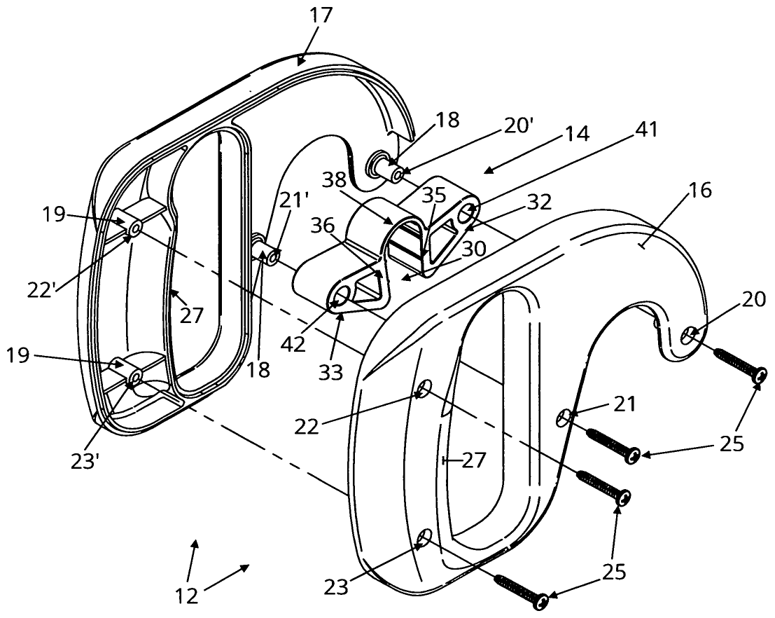

The plastic pistol grip handle 12 may be made from any suitable relatively rigid plastic, such as ABS, and by any suitable conventional technique, such as injection molding. As shown most clearly in FIG. 3, the pistol grip handle 12 may be formed in two parts, 16 & 17. The parts 16, 17 may be mirror images of each other, or only one of the parts 16, 17 may have the mounting tubes 18 which facilitate mounting of the flexible element 14, and the additional mounting tubes 19. Cooperating openings 20, 21, 22, & 23 in part 16 and 20′, 21′, 22′, & 23′ in the part 17 may be provided for receipt of mechanical fasteners (e. g. screws) 25 for holding the parts 16, 17, together. In this example the screws 25 pass through the openings 20-23 and into the openings 20′-23′ in the tubes 18, 19. The openings 20′-23′ may be internally screw-threaded to receive the screws 25, or may have a slightly smaller diameter than the exterior diameter of the screws 25 so that the screws 25 bite into the plastic of the tubes 18, 19 defining the openings 20′-23′.

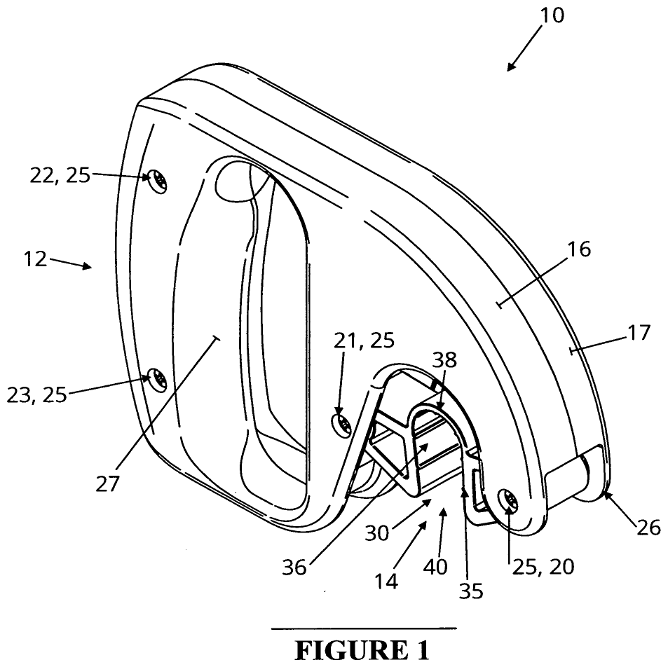

In the preferred embodiment illustrated in the drawings the forward-most portion 26 (FIGS. 1 & 2) of the plastic grip handle 12 has a smooth or even flat termination (i. e. is devoid of one or more projections extending forwardly thereof). Under some circumstances, however, one or more forwardly-extending projections may be provided for stability or other purposes.

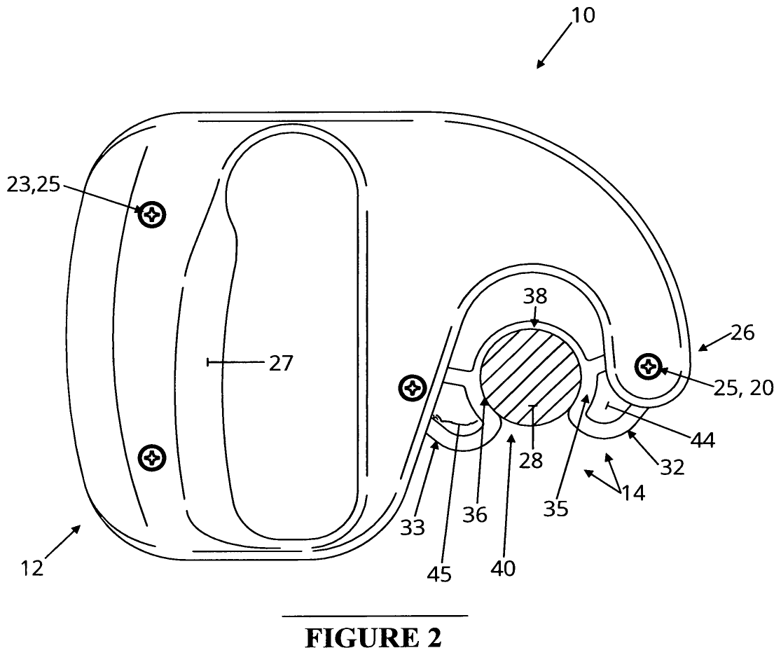

Other mechanisms for fastening the parts 16, 17 together may alternatively be provided such as conventional adhesive, nuts and bolts, pop rivets, etc. The structure 12 may be made especially ergonomic as illustrated by the curved, sculptured, portion 27 seen most clearly in FIGS. 2 & 3, facilitating a comfortable yet secure grasp by the user's hand (adapted to be engaged by the user's fingers) and comfortable and effective control of a shopping cart with which the hygienic grip is utilized. The ergonomic configuration illustrated at 27 is superior to a grip with finger-receiving indentations.

The construction of the structures 12 shown in the drawing allows the user to very effectively and conveniently control the movement of a shopping cart or the like. Especially where first and second structures 12 are used at spaced points along the length of a conventional elongated handle of a grocery cart or the like the user's control is even better and more comfortable than by utilization of the conventional grocery cart handle alone. FIG. 2 shows in cross-section a substantially circular cross-section conventional cart handle 28 in use with the device 10. The handle 28 is a conventional shopping cart handle such as shown in U.S. Pat. Nos 5,820,142 and 6,817,066, the disclosures of which are incorporated by reference herein. One of the significant characteristics of the structure 12 is that it provides a remote mounting structure for holding the flexible element 14 in place during use and facilitating movement of the flexible element 14 on and off a cart handle 28 without the possibility of the user inadvertently touching the cart handle 28 during installation and/or removal.

In a broader sense, the grip 10 according to the invention comprises the plastic pistol grip handle 12 and a general U-shaped portion (in the exemplary embodiment illustrated the U-shaped element 30) adapted to engage the generally circular cross-section of cart handle 28.

An exemplary flexible element 14 according to the invention is seen in all of FIGS. 1-3 and most clearly in FIG. 3. The element 14 may be made of a rubber-like material, such as EPDM, silicone rubber, natural rubber, neoprene rubber, or the like, and may be constructed using any suitable conventional technique. The element 14 as illustrated in FIG. 3 has three portions, the main generally U-shaped portion 30, and the first and second wing portions 32, 33, respectively. As any general U-shape, the portion 30 has legs 35, 36, a closed curved end 38, and an open end 40. The open end 40 faces outwardly when the element 14 is connected to the structure 12. The U is dimensioned and configured so that when it is deformed by moving it into contact with a cart handle 28 it will move into place to grip the cart handle 28, such as seen in FIG. 2.

The legs 35, 36, of the generally U-shaped portion 30 can elastically and/or frictionally engage the shopping cart handle 28 to hold the hygienic grip 10 in place and/or the legs 35, 36 may “snap” around the shopping cart handle to hold the hygienic grip 10 in place with the shopping cart handle 28 also engaging the curved closed end 38 of the U, as seen in FIG. 2. That is the legs 35, 36 may be slanted slightly together as seen in the drawings, or may even be significantly slanted toward each other such as are the legs of the element 141 in FIGS. 44-48 of U.S. Pat. No. 5,820,142.

The wing portions 32, 33 are desirably provided to mount the generally U-shaped portion 30 to the element 12. As seen most clearly in FIG. 3, when the wing portions 32, 33 are provided they have the openings 41, 42, respectively which are slightly larger than the exterior diameter of the tubes 18. The tubes 18 pass through the openings 41, 42 to properly position the element 14 in place mounted in the structure 12 so that when the fasteners 25 are passed through the openings 20, 21 into the tubes 18 the structure 10, 12, 14 is ready for use.

While the portions 30, 32, 33 can be formed of separate pieces that are held together by ultrasonic welding, adhesive, or another conventional mechanism, it is desirable that the portions 30, 32, 33 be molded during use into one integral resilient component, as seen in the drawings. The openings 44, 45 (FIG. 2) are preferably provided so as to reduce the amount of material and to facilitate flexibility of the element 14. Alternatively, while the construction illustrated and described above is most desirable instead of the inherent resiliency of the material of the element 14 flexibility may be provided by springs (e. g. coil, disc, leaf, or the like) acting on one or both of the legs 35, 36 from adjacent the tubes 18 as schematically illustrated at 45 in FIG. 2 to bias one or both of the legs 35, 36 into gripping engagement with the cart handle 28.

One advantage of the flexible element 14 illustrated in the drawings is that it is per se commercially available (although for an entirely different purpose). The element 14 may be purchased from the Home Depot website and is referred to as a large storage rubber grip wall mount holder. A useable modification thereof is also commercially available from SDV International Co., Ltd., known as a rubber storage clip.

The hygienic grip 10 according to the invention is readily utilizable in a method of using a cart having an elongated handle 28. The method preferably employs using first and second hygienic grips 10 by: a) manually moving the flexible elements 14 of the hygienic grips 10 into contact with spaced portions of the elongated cart handle 28 using only the remote mounting structure 12 so that there is no probability of the user inadvertently touching the cart handle; and b) ultimately manually removing the hygienic grips from contact with the cart handle using only the remote mounting structure 12. The procedure a) is preferably accomplished by aligning the open end 40 of the generally U-shaped portion 30 with the cart handle 28 and then manually pushing down on the structure 12 to move the legs 35, 36 and/or the closed curved end 38 into securing contact with the cart handle 28. Procedure b) is preferably accomplished simply by manually pulling the structure 12 up and away from the cart handle 28. The method may further comprise c), after b), manually sanitizing the portions of each of the flexible elements 14 that contacted the cart handle 28; c) may be practiced using an at least 60% alcohol spray, or a conventional alcohol wipe or the like. The hygienic grips 10 may be stored in a conventional zip-lock plastic bag for future use.

While the invention has been herein shown and described in preferred embodiments thereof it is to be recognized that the invention is to be interpreted broadly so as to encompass all equivalent structures and procedures, limited only by the prior art.

1. A hygienic grip for a cart handle comprising: a flexible element dimensioned and configured so that when it is deformed by moving it into contact with a cart handle it will move into place to grip a cart handle; and a remote mounting structure for holding said flexible element in place during use and facilitating movement of said flexible element on and off a cart handle without the possibility of the user inadvertently touching the cart handle.

2. A hygienic grip as recited in claim 1 wherein said flexible element comprises a rubber-like element having a generally U-shaped portion.

3. A hygienic grip as recited in claim 1 wherein said remote mounting structure comprises a plastic pistol grip handle which is securely mounted to said flexible element.

4. A hygienic grip as recited in claim 2 wherein said remote mounting structure comprises a plastic pistol grip handle which is securely mounted to said flexible element.

5. A hygienic grip as recited in claim 3 wherein said plastic pistol grip handle comprises an ergonomic curved sculptured portion adapted to be engaged by a user's fingers.

6. A hygienic grip as recited in claim 2 wherein said flexible element comprises first and second legs which when moved into engagement with a cart handle grip the cart handle.

7. A hygienic grip as recited in claim 6 wherein the inherent resilience of said first and second legs bias said legs into gripping contact with a cart handle.

8. A hygienic grip as recited in claim 6 further comprising a spring for biasing at least one of said first and second legs into gripping contact with a cart handle,

9. A hygienic grip as recited in claim 5 wherein said flexible element comprises first and second legs which when moved into engagement with a cart handle grip the cart handle.

10. A hygienic grip as recited in claim 9 wherein the inherent resilience of said first and second legs bias said legs into gripping contact with a cart handle.

11. A hygienic grip as recited in claim 9 further comprising a spring for biasing at least one of said first and second legs into gripping contact with a cart handle

12. A hygienic grip as recited in claim 3 wherein said pistol grip handle comprises a forward-most portion that is smooth, devoid of one or more projections.

13. A method of using a cart having an elongated handle using first and second hygienic grips as recited in claim 1 by: a) manually moving the flexible elements of the hygienic grips into contact with spaced portions of the elongated cart handle using only the remote mounting structure so that there is no probability of the user inadvertently touching the cart handle; and b) ultimately manually removing the hygienic grips from contact with the cart handle using only the remote mounting structure.

14. A method as recited in claim 13 further comprising c), after b), manually sanitizing the portions of each of the flexible elements that contacted the cart handle.

15. A method as recited in claim 14 wherein c) is practiced using an at least 60% alcohol spray.

16. A hygienic grip comprising: a plastic pistol grip handle; and a flexible element having a roughly U-shaped configuration portion mounted securely by said plastic pistol grip handle with the open portion of the U facing outwardly from said plastic pistol grip handle.

17. A hygienic grip as recited in claim 16 wherein said pistol grip handle comprises a forward-most portion that is smooth, devoid of one or more projections.

18. A hygienic grip as recited in claim 17 wherein said plastic pistol grip handle comprises an ergonomic curved sculptured portion adapted to be engaged by a user's fingers.

19. A hygienic grip as recited in claim 17 wherein said flexible element comprises first and second legs which when moved into engagement with a cart handle grip the cart handle.

20. A hygienic grip comprising a plastic pistol grip handle and a generally U-shaped portion adapted to engage a generally circular cross-section cart handle.
